(19) United States
(12) Patent Application Publication
(10) Pub. No.: US 2026/0353257 A1
(43) Pub. Date: Nov. 5, 2026

(54) ACTIVATION, ADAPTATION, AND DEACTIVATION OF ON-DEMAND SSB

(71) Applicant: Samsung Electronics Co., Ltd., Suwon-si (KR)

(72) Inventor: Hongbo Si, Allen, TX (US)

(21) Appl. No.: 19/635,605

(22) Filed: Mar. 31, 2026

Related U.S. Application Data
(60) Provisional application No. 63/798,099, filed on May 1, 2025.

(51) Int. Cl. H04W 48/14

(52) U.S. Cl. CPC H04W 48/14

(57) ABSTRACT

Apparatuses and methods for activation, adaptation, and deactivation of on-demand synchronization signal blocks (SSBs). A method performed by a user equipment includes receiving a set of higher layer parameters for a secondary cell (SCell) and identifying, based on the set of higher layer parameters, a list of configurations for a SSB. Each configuration in the list of configurations includes a periodicity, a system frame number (SFN) offset, a half frame index, and an indication of actually transmitted SSB indexes for the SSB. The method further includes receiving, based on a first configuration, a first downlink signaling indicating an activation of a transmission of the SSB, receiving, based on a second configuration, a second downlink signaling indicating an adaptation of a configuration for the transmission of the SSB, and receiving, based on a third configuration, a third downlink signaling indicating a deactivation of the transmission of the SSB.

### CROSS-REFERENCE TO RELATED AND CLAIM OF PRIORITY

The present application claims priority under 35 U.S.C. § 119(e) to U.S. Provisional Patent Application No. 63/798,099 filed on May 1, 2025, which is hereby incorporated by reference in its entirety.

### TECHNICAL FIELD

The present disclosure relates generally to wireless communication systems and, more specifically, the present disclosure is related to a method and apparatus of activation, adaptation, and deactivation of on-demand synchronization signal blocks (SSBs) and/or synchronization signal and physical broadcast channel (SS/PBCH) blocks.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus of activation, adaptation, and deactivation of on-demand SSBs.

In one embodiment, a user equipment (UE) in a wireless communication system is provided. The UE includes a transceiver configured to receive a set of higher layer parameters for a secondary cell (SCell); and a processor operably coupled to the transceiver. The processor is configured to identify, based on the set of higher layer parameters, a list of configurations for a SS/PBCH block. Each configuration in the list of configurations includes a periodicity for the SS/PBCH block, a system frame number (SFN) offset for the SS/PBCH block, a half frame index for the SS/PBCH block, and an indication of actually transmitted SS/PBCH block indexes for the SS/PBCH block. The transceiver is further configured to receive, based on a first configuration in the list of configurations, a first downlink signaling indicating an activation of a transmission of the SS/PBCH block, receive, based on a second configuration in the list of configurations, a second downlink signaling indicating an adaptation of a configuration for the transmission of the SS/PBCH block, and receive, based on a third configuration in the list of configurations, a third downlink signaling indicating a deactivation of the transmission of the SS/PBCH block.

In another embodiment, a method of a UE in a wireless communication system is provided. The method includes receiving a set of higher layer parameters for a SCell and identifying, based on the set of higher layer parameters, a list of configurations for a SS/PBCH block. Each configuration in the list of configurations includes a periodicity for the SS/PBCH block, a SFN offset for the SS/PBCH block, a half frame index for the SS/PBCH block, and an indication of actually transmitted SS/PBCH block indexes for the SS/PBCH block. The method further includes receiving, based on a first configuration in the list of configurations, a first downlink signaling indicating an activation of a transmission of the SS/PBCH block, receiving, based on a second configuration in the list of configurations, a second downlink signaling indicating an adaptation of a configuration for the transmission of the SS/PBCH block, and receiving, based on a third configuration in the list of configurations, a third downlink signaling indicating a deactivation of the transmission of the SS/PBCH block.

In yet another embodiment, a base station (BS) in a wireless communication system is provided. The BS includes a processor configured to determine a list of configurations for a SS/PBCH block. Each configuration in the list of configurations includes a periodicity for the SS/PBCH block, a SFN offset for the SS/PBCH block, a half frame index for the SS/PBCH block, and an indication of actually transmitted SS/PBCH block indexes for the SS/PBCH block. The BS further includes a transceiver operably coupled to the processor. The transceiver is configured to transmit a set of higher layer parameters for a SCell that includes the list of configurations, transmit, based on a first configuration in the list of configurations, a first downlink signaling indicating an activation of a transmission of the SS/PBCH block, transmit, based on a second configuration in the list of configurations, a second downlink signaling indicating an adaptation of a configuration for the transmission of the SS/PBCH block, and transmit, based on a third configuration in the list of configurations, a third downlink signaling indicating a deactivation of the transmission of the SS/PBCH block.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates example method for using a higher layer parameter to activate on-demand SS/PBCH block transmission according to embodiments of the present disclosure;

FIG. 6 illustrates an example of using MAC CE for activation, adaptation, and deactivation of on-demand SSB according to embodiments of the present disclosure;

FIG. 7 illustrates an example method for using a MAC CE to adapt parameters for an on-demand SS/PBCH block transmission according to embodiments of the present disclosure; and

FIG. 8 illustrates an example method performed by a UE in a wireless communication system according to embodiments of the present disclosure.

### DETAILED DESCRIPTION

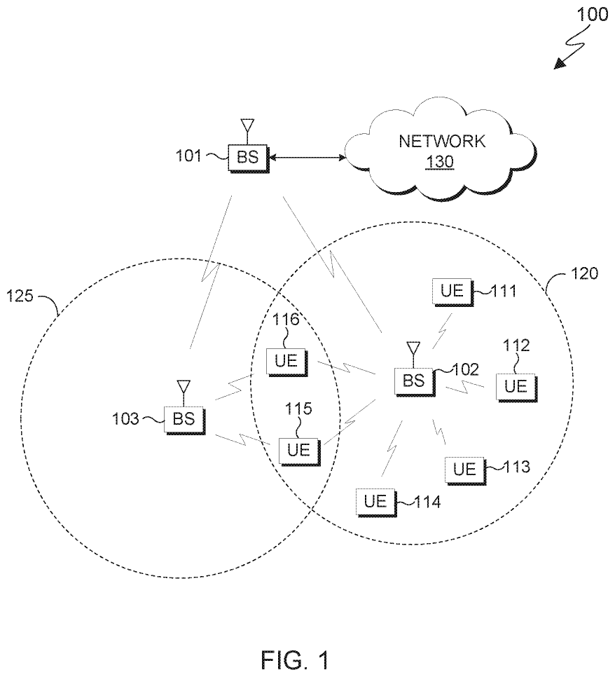

FIGS. 1-8 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v 17.1.0, “NR; Physical channels and modulation” (herein, “REF 1”); 3GPP TS 38.212 v 17.1.0, “NR; Multiplexing and channel coding” (herein, “REF 2”); 3GPP TS 38.213 v 17.1.0, “NR; Physical layer procedures for control” (herein, “REF 3”); 3GPP TS 38.214 v 17.1.0, “NR; Physical layer procedures for data” (herein, “REF 4”); and 3GPP TS 38.331 v 17.1.0, “NR; Radio Resource Control (RRC) protocol specification” (herein, “REF 5”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for activation, adaptation, and deactivation of on-demand SSBs. In certain embodiments, one or more of the BSs 101-103 include circuitry, programing, or a combination thereof to enable activation, adaptation, and deactivation of on-demand SSBs.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

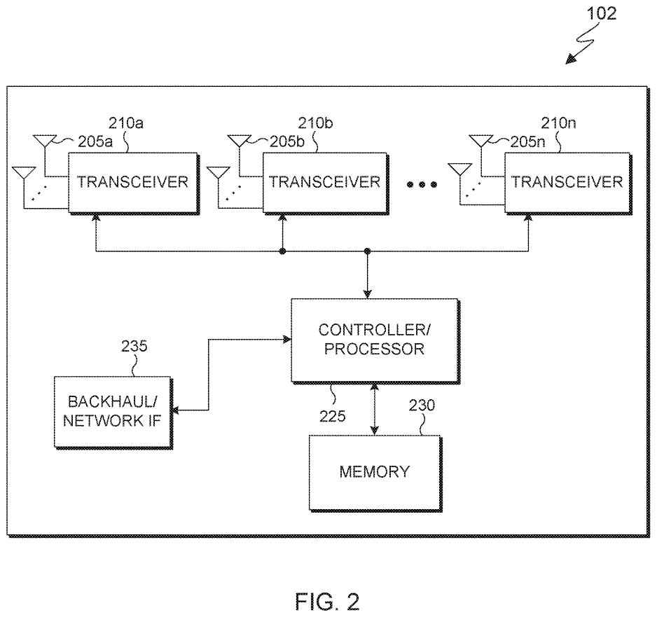

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for activation, adaptation, and deactivation of on-demand SSBs. Any of a wide variety of other functions could be supported in the BS 102 by the controller/processor 225.

The controller/processor 225 is also capable of executing programs and other processes resident in the memory 230, such as processes to enable activation, adaptation, and deactivation of on-demand SSBs. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

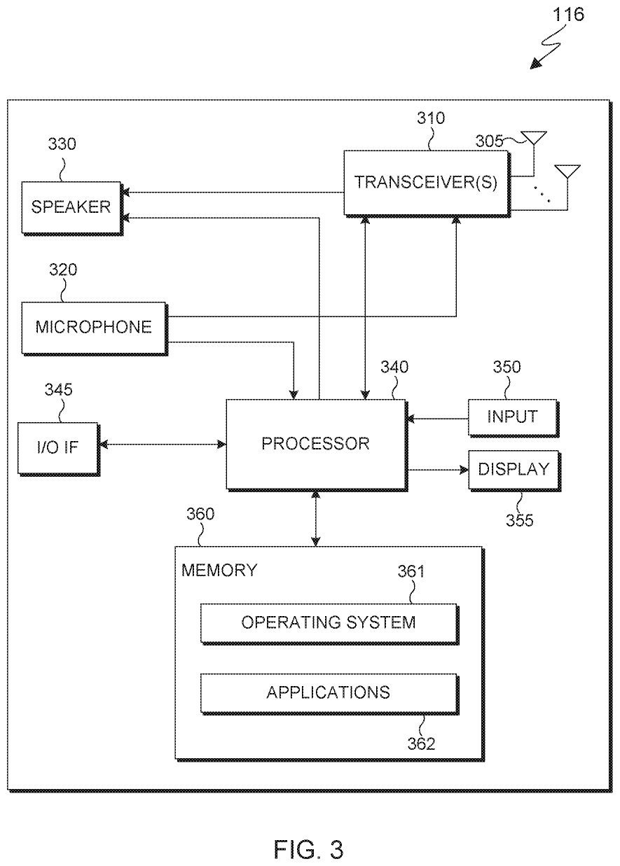

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for activation, adaptation, and deactivation of on-demand SSBs as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

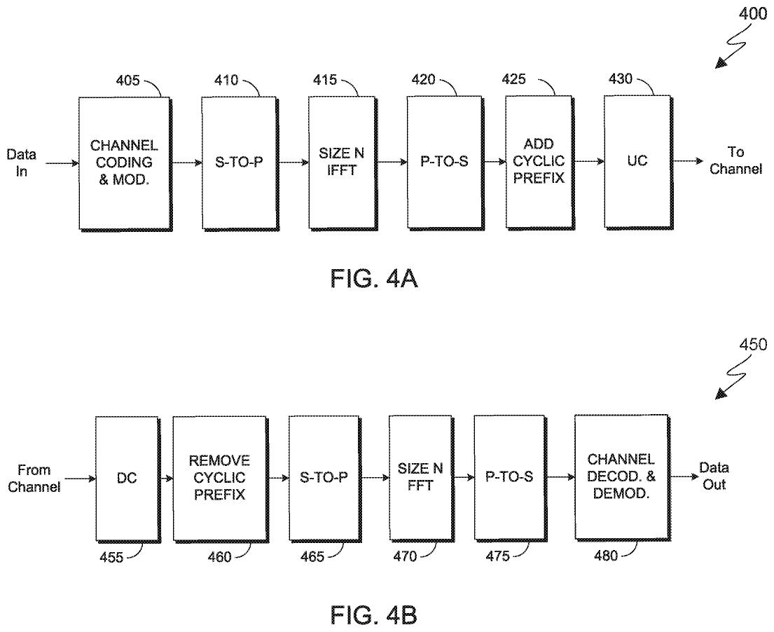

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting activation, adaptation, and deactivation of on-demand SSBs as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In new radio (NR), for a secondary cell (SCell) implemented with periodic synchronization signals/physical broadcast channel (SS/PBCH) block transmission (or always-on SSB), a UE can be provided with a configuration for radio resource management (RRM) measurement based on the periodic SS/PBCH block, wherein the configuration can be provided by a radio resource control (RRC) parameter. After the RRM measurement, the BS can provide a configuration of the SCell, e.g., by another RRC parameter. The UE can be further provided with a medium access control (MAC) control element (CE) indicating an activation of the SCell, and by using the periodic SS/PBCH blocks on the SCell, or tracking reference signal (TRS) if configured, or the SS/PBCH blocks on the primary cell (PCell) when the SCell is without periodic SS/PBCH block transmission, the UE can get synchronized with the SCell and get ready to transmit or receive on the SCell. After activation of the SCell, if the SCell gets loss of synchronization, the UE can use the periodic SS/PBCH block for resynchronization. Since SS/PBCH block is transmitted on the SCell periodically, the power consumption for SS/PBCH block can be significantly large. Accordingly, embodiments of the present provide procedures and mechanisms for activation, adaptation, and deactivation of the on-demand SSB (OD-SSB).

For example, various embodiments of the present disclosure are applicable for RRC_CONNECTED mode. For another example, various embodiments of the present disclosure are applicable for RRC_IDLE mode. For yet another example, various embodiments of the present disclosure are applicable for RRC_INACTIVE mode. For one example, various embodiments of the present disclosure are applicable for a PCell. For another example, various embodiments of the present disclosure are applicable for an SCell. For yet another example, various embodiments of the present disclosure are applicable for a PSCell. For one example, various embodiments of the present disclosure are applicable for AO-SSB as cell-defining SSB (e.g., with associated SIB1 transmission). AO-SSB refers to an always-on SSB. For another example, various embodiments of the present disclosure are applicable for AO-SSB as non-cell-defining SSB (e.g., without associated SIB1 transmission). For one example, various embodiments of the present disclosure are applicable for AO-SSB located at a frequency layer given by a synchronization raster entry. For another example, various embodiments of the present disclosure are applicable for AO-SSB located at a frequency layer not given by a synchronization raster entry.

Various embodiments of the present disclosure provide for:
Configuration for on-demand SSb;
Using RRC parameter for activating on-demand SSB transmission, including:
   Timeline for using RRC parameter for activating on-demand SSB transmission, and
   UE procedure for using RRC parameter for activating on-demand SSB transmission;
Using MAC CE for activating, adapting, and deactivating on-demand SSB transmission, including:
   Timeline for using MAC CE for adapting parameters for on-demand SSB transmission; and
   UE procedure for using MAC CE for adapting on-demand SSB transmission.

In one embodiment, a UE can be provided one or multiple configurations about on-demand SS/PBCH block by higher layer parameters, i.e., RRC (e.g., od-ssb-Config, or od-ssb-TimeConfig, or od-ssb-TimeSpatialConfig), e.g., to formulate a list (e.g., od-ssb-ConfigList, or od-ssb-TimeConfigList, or od-ssb-TimeSpatialConfigList) of the one or multiple configurations, wherein a configuration within the one or multiple configurations can include at least one of the following components:
Component 1: A periodicity for the on-demand SS/PBCH block burst or transmission, e.g., od-ssb-Periodicity
Component 2: A SFN offset indicating the SFN for the on-demand SS/PBCH block burst or transmission, e.g., od-ssb-SFN-Offset
Component 3: A half frame index indicating the half frame in the SFN for the on-demand

SS/PBCH block burst or transmission, e.g., od-ssb-halfFrameIndex
Component 4: An indication of actually transmitted SSB (indices) in a burst for the on-demand SS/PBCH block burst or transmission, e.g., od-ssb-PositionsInBurst
Component 5: A number of bursts for the on-demand SS/PBCH block transmission, e.g., od-ssb-NrOfBurst

For one further implementation, the periodicity for the on-demand SS/PBCH block burst or transmission (e.g., od-ssb-Periodicity) can be absent from a configuration (e.g., an optional field in the configuration), and a UE can assume the periodicity for the on-demand SS/PBCH block burst or transmission can be same as always-on SS/PBCH block burst or transmission in the same cell (e.g., ssb-periodicityServingCell).

For another further implementation, the periodicity for the on-demand SS/PBCH block burst or transmission (e.g., od-ssb-Periodicity) can be assumed to be always present in a configuration (e.g., a mandatory field in the configuration).

For yet another further implementation, the SFN offset indicating the SFN for the on-demand SS/PBCH block burst or transmission (e.g., od-ssb-SFN-Offset) can be absent from a configuration (e.g., an optional field in the configuration), and a UE can assume the SFN offset is 0.

For yet another further implementation, the half frame index indicating the half frame in the SFN for the on-demand SS/PBCH block burst or transmission (e.g., od-ssb-halfFrameIndex) can be absent from a configuration (e.g., an optional field in the configuration), and a UE can assume the half frame index is 0.

For yet another further implementation, the indication of actually transmitted SSB (indices) in a burst for the on-demand SS/PBCH block burst or transmission (e.g., od-ssb-PositionsInBurst) can be absent from a configuration (e.g., an optional field in the configuration), and a UE can assume the indication of actually transmitted SSB in a burst for the on-demand SS/PBCH block burst or transmission can be same as always-on SS/PBCH block burst or transmission in the same cell (e.g., ssb-PositionsInBurst).

For yet another further implementation, the indication of actually transmitted SSB (indices) in a burst for the on-demand SS/PBCH block burst or transmission (e.g., od-ssb-PositionsInBurst) can be present in a configuration (e.g., an optional field in the configuration) when always-on SS/PBCH block burst or transmission is not present in the same cell (e.g., absoluteFrequencySSB is not provided), or when the center frequency of on-demand SS/PBCH block and the center frequency of always-on SS/PBCH block are not the same (e.g., absoluteFrequencySSB and od-absoluteFrequencySSB are not the same).

For yet another further implementation, the number of bursts for the on-demand SS/PBCH block transmission (e.g., od-ssb-NrOfBurst) can be absent from a configuration (e.g., an optional field in the configuration), and a UE can assume there is no limit on the number of bursts for the on-demand SS/PBCH block transmission (e.g., infinite number of bursts). For one instance, this can be applicable when the on-demand SS/PBCH block transmission is activated by a RRC.

In one example, the maximum number of configurations in the one or multiple configurations (e.g., per the serving cell with the on-demand SS/PBCH block) can be X, e.g., X=8, or X=16, or X=32, or X=64.
For one further implementation, X can be subject to a UE capability and reported by the UE.
For another further implementation, X can be provided in UE assistance information.

In the present disclosure, examples of using RRC for activating an on-demand SSB transmission are provided.

In one embodiment, the transmission of the on-demand SS/PBCH block can be indicated to be activated by higher layer parameter (e.g., RRC parameter).

In one example, the UE can provided with an indication of an activation of the on-demand SS/PBCH block transmission by the same higher layer parameters that provides the one or multiple configurations about on-demand SS/PBCH block (e.g., one separate field in the higher layer parameters providing the indication), and the UE applies a configuration from the one or multiple configurations for the activation of the on-demand SS/PBCH block, based on the indication.
For one instance, the configuration can be the first (or last) configuration in the one or multiple configurations.
For another instance, the configuration can be the first (or last) configuration within the configuration(s) that do not include the component of the number of bursts for the on-demand SS/PBCH block transmission (e.g., od-ssb-NrOfBurst).
For yet another instance, the UE can assume the configuration does not include the component of the number of bursts for the on-demand SS/PBCH block transmission (e.g., od-ssb-NrOfBurst).
For yet another instance, when the UE applies the configuration, the component of the number of bursts for the on-demand SS/PBCH block transmission (e.g., od-ssb-NrOfBurst) is not applied, e.g., the UE assumes the on-demand SS/PBCH block transmission has no limit on the number of bursts.
For yet another instance, when the UE applies the configuration, the component of the indication of actually transmitted SSB in a burst for the on-demand SS/PBCH block burst or transmission (e.g., od-ssb-PositionsInBurst) is not applied, e.g., the UE assumes the indication of actually transmitted SSB in a burst for the on-demand SS/PBCH block burst or transmission is same as always-on SS/PBCH block burst or transmission in the same cell (e.g., ssb-PositionsInBurst).

In another example, the UE can provided with an indication of an activation of the on-demand SS/PBCH block transmission associated with an index of the configuration to apply by the same higher layer parameters that provides the one or multiple configurations about on-demand SS/PBCH block (e.g., one separate field in the higher layer parameters providing the indication), and the UE applies the indicated configuration from the one or multiple configurations for the activation of the on-demand SS/PBCH block.

In the present disclosure, an example timeline for activation of an on-demand SSB transmission by RRC is provided.

In one embodiment, when the PDSCH reception providing the higher layer parameter for indicating the activation of the on-demand SS/PBCH block transmission ends in slot n, the UE expects that the on-demand SS/PBCH block transmission according to the determined parameters (e.g., according to example of the present disclosure, such as the parameters in the configuration) starts based on at least one of the following examples or a combination of at least one of the following examples.
For one further implementation, this is applicable at least when the UE determines the number of bursts for the on-demand SS/PBCH block transmission (e.g., od-ssb-NrOfBurst).

For one example, the on-demand SS/PBCH block transmission starts from the next half frame after slot n.

For another example, the on-demand SS/PBCH block transmission starts from the next half frame after slot n, wherein the next half frame is selected from a set of candidate half frames and the set of candidate half frames are determined based on the parameters for the on-demand SS/PBCH block transmission (e.g., according to example of the present disclosure, such as the parameters in the default configuration), such as the periodicity for the on-demand SS/PBCH block burst or transmission (e.g., od-ssb-Periodicity), the SFN offset indicating the SFN for the on-demand SS/PBCH block burst or transmission (e.g., od-ssb-SFN-Offset), and the half frame index indicating the half frame in the SFN for the on-demand SS/PBCH block burst or transmission (e.g., od-ssb-halfFrameIndex).

For yet another example, the on-demand SS/PBCH block transmission starts after slot n+T_RRC, wherein T_RRC is the (minimum) processing delay for the higher layer parameter.

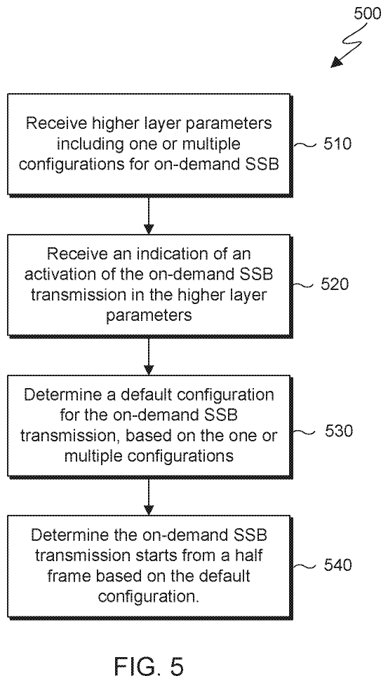

FIG. 5 illustrates an example method 500 for using a higher layer parameter to activate on-demand SS/PBCH block transmission that may be performed by a UE in a wireless communication system according to embodiments of the present disclosure. The method 500 of can be performed by any of the UEs 111-116 of FIG. 1, such as the UE 116 of FIG. 3, and a corresponding method can be performed by any of the BSs 101-103 of FIG. 1, such as BS 102 of FIG. 2. The method 500 is for illustration only and other embodiments can be used without departing from the scope of the present disclosure.

The method 500 begins with a UE receiving higher layer parameters (510). In various embodiments, these parameters may include one or multiple configurations for an on-demand SSB. The UE then receives an indication of an activation of the on-demand SSB transmission in the higher layer parameters (520). The UE then determines a default configuration for the on-demand transmission, based on the one or multiple configurations (530). The UE then determines that the on-demand SSB transmission starts from a half frame based on the default configuration (540).

Although FIG. 5 illustrates one example method 500 of the actions taken by the UE for activating on-demand SS/PBCH block transmission, various changes may be made to FIG. 5. For example, while shown as a series of steps, various steps in FIG. 5 could overlap, occur in parallel, occur in a different order, or occur any number of times.

In the present disclosure, examples of using MAC CE for activation, adaptation, and deactivation of on-demand SSB transmission are provided.

In one embodiment, the UE can be provided with a MAC CE for indicating an activation of the on-demand SS/PBCH block transmission, or an adaptation of the parameters for the on-going on-demand SS/PBCH block transmission (e.g., already activated on-demand SS/PBCH block transmission), or a termination/deactivation of the on-demand SS/PBCH block transmission.

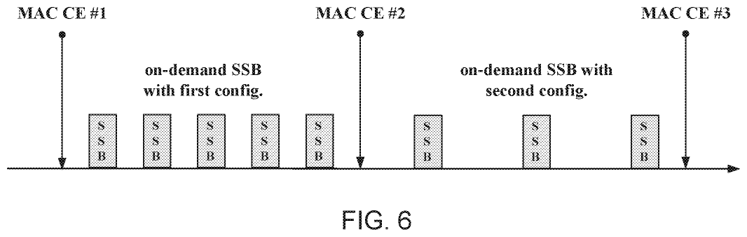

FIG. 6 illustrates an example of using MAC CE for activation, adaptation, and deactivation of on-demand SSB according to embodiments of the present disclosure. For example, the procedure can be implemented by BS 102 of FIG. 1. This example is for illustration only and other embodiments can be used without departing from the scope of the present disclosure.

As illustrated in FIG. 6, MAC CE can be used to activate the on-demand SSB (e.g., by MAC CE #1 in FIG. 6), adapt a parameter of the on-demand SSB (e.g., by MAC CE #2 in FIG. 6), or deactivate the on-demand SSB (e.g., by MAC CE #3 in FIG. 6).

For one example, the number of bits for indicating an index of the configuration in the one or multiple configurations for a given serving cell, carried by the MAC CE, can be determined as Y.
For one instance, Y=log2(X).
For another instance, Y=┌log2(X′)┐, wherein X′ is the number of configurations in the one or multiple configurations, and X′≤X.
For yet another instance, Y can be provided by a higher layer parameter.

For one example, after (or if) a UE receives the higher layer parameters to indicate the activation of the on-demand SS/PBCH block transmission, the UE may not expect to receive a MAC CE to indicate the activation of the on-demand SS/PBCH block transmission or adaptation of parameters for the on-going (e.g., activated) on-demand SS/PBCH block transmission, e.g., before the SCell is activated.

For another example, after (or if) a UE receives a first MAC CE to indicate the activation of the on-demand SS/PBCH block transmission, the UE may not expect to receive a second MAC CE to indicate the activation of the on-demand SS/PBCH block transmission or adaptation of parameters for the on-going (e.g., activated) on-demand SS/PBCH block transmission, e.g., before the SCell is activated.

For one example, if a UE receives the higher layer parameters to indicate the activation of the on-demand SS/PBCH block transmission, and/or determines the number of bursts for the on-demand SS/PBCH block transmission (e.g., according to example in the present disclosure), then the UE does not expect to receive the MAC CE for indicating the adaptation of parameters for the on-going (e.g., activated) on-demand SS/PBCH block transmission, e.g., when the SCell is activated.

For another example, if a UE receives the higher layer parameters to indicate the activation of the on-demand SS/PBCH block transmission, and/or determines the number of bursts for the on-demand SS/PBCH block transmission (e.g., according to example in the present disclosure), then the UE does not expect to receive the MAC CE for indicating the adaptation of parameters for the on-going (e.g., activated) on-demand SS/PBCH block transmission during the number of bursts for the on-demand SS/PBCH block transmission (e.g., before the number of bursts for the on-demand SS/PBCH block transmission completes), e.g., when the SCell is activated.

For yet another example, if a UE receives the higher layer parameters to indicate the activation of the on-demand SS/PBCH block transmission, and/or determines the number of bursts for the on-demand SS/PBCH block transmission (e.g., according to example in the present disclosure), the UE may receive the MAC CE for indicating the adaptation of parameters for the on-going (e.g., activated) on-demand SS/PBCH block transmission, e.g., when the SCell is activated, then the UE determines the on-demand SS/PBCH block transmission with the indicated parameter by the MAC CE (e.g., ignore the remaining number of bursts for the on-demand SS/PBCH block transmission).
For one further implementation, the UE receives the MAC CE before the number of bursts for the on-demand SS/PBCH block transmission completes (i.e., the on-demand SS/PBCH block transmission is still on-going).
For another further implementation, the UE receives the MAC CE after the number of bursts for the on-demand SS/PBCH block transmission completes.
For yet another further implementation, the UE may expect the MAC CE indicates a number of bursts for the on-demand SS/PBCH block transmission after the adaptation.
For yet another further implementation, the UE may ignore the number of bursts for the on-demand SS/PBCH block transmission indicated by the MAC CE (if indicated) and continue to use the number of bursts for the on-demand SS/PBCH block transmission determined when activating after the adaptation.

For yet another example, if a UE receives the higher layer parameters to indicate the activation of the on-demand SS/PBCH block transmission, and/or does not determine the number of bursts for the on-demand SS/PBCH block transmission (e.g., according to example in the present disclosure), the UE may receive the MAC CE for indicating the adaptation of parameters for the on-going (e.g., activated) on-demand SS/PBCH block transmission, e.g., when the SCell is activated, then the UE determines the on-demand SS/PBCH block transmission with the indicated parameter by the MAC CE.
For one further implementation, the UE may expect the MAC CE does not indicate a number of bursts for the on-demand SS/PBCH block transmission after the adaptation.

For one example, if a UE receives a first MAC CE to indicate the activation of the on-demand SS/PBCH block transmission, and/or determines the number of bursts for the on-demand SS/PBCH block transmission (e.g., according to example in the present disclosure), then the UE does not expect to receive a second MAC CE for indicating the adaptation of parameters for the on-going (e.g., activated) on-demand SS/PBCH block transmission, e.g., when the SCell is activated.

For another example, if a UE receives a first MAC CE to indicate the activation of the on-demand SS/PBCH block transmission, and/or determines the number of bursts for the on-demand SS/PBCH block transmission (e.g., according to example in the present disclosure), then the UE does not expect to receive a second MAC CE for indicating the adaptation of parameters for the on-going (e.g., activated) on-demand SS/PBCH block transmission during the number of bursts for the on-demand SS/PBCH block transmission (e.g., before the number of bursts for the on-demand SS/PBCH block transmission completes), e.g., when the SCell is activated.

For yet another example, if a UE receives a first MAC CE to indicate the activation of the on-demand SS/PBCH block transmission, and/or determines the number of bursts for the on-demand SS/PBCH block transmission (e.g., according to example in the present disclosure), the UE may receive a second MAC CE for indicating the adaptation of parameters for the on-going (e.g., activated) on-demand SS/PBCH block transmission, e.g., when the SCell is activated, then the UE determines the on-demand SS/PBCH block transmission with the indicated parameter by the second MAC CE (e.g., ignore the remaining number of bursts for the on-demand SS/PBCH block transmission).
For one further implementation, the UE receives the second MAC CE before the number of bursts for the on-demand SS/PBCH block transmission completes (i.e., the on-demand SS/PBCH block transmission is still on-going).
For another further implementation, the UE receives the second MAC CE after the number of bursts for the on-demand SS/PBCH block transmission completes.
For yet another further implementation, the UE may expect the second MAC CE indicates a number of bursts for the on-demand SS/PBCH block transmission after the adaptation.
For yet another further implementation, the UE may ignore the number of bursts for the on-demand SS/PBCH block transmission indicated by the second MAC CE (if indicated) and continue to use the number of bursts for the on-demand SS/PBCH block transmission indicated by the first MAC CE after the adaptation.

For yet another example, if a UE receives a first MAC CE to indicate the activation of the on-demand SS/PBCH block transmission, and/or does not determine the number (e.g., N) of bursts for the on-demand SS/PBCH block transmission (e.g., according to example in the present disclosure), the UE may receive a second MAC CE for indicating the adaptation of parameters for the on-going (e.g., activated) on-demand SS/PBCH block transmission, e.g., when the SCell is activated, then the UE determines the on-demand SS/PBCH block transmission with the indicated parameter by the second MAC CE.
For one further implementation, the UE may expect that the second MAC CE does not indicate a number of bursts for the on-demand SS/PBCH block transmission after the adaptation.

For one example, if a UE receives the higher layer parameters to indicate the activation of the on-demand SS/PBCH block transmission, and/or determines the number of bursts for the on-demand SS/PBCH block transmission (e.g., according to example in the present disclosure), then the UE does not expect to receive the MAC CE for indicating the deactivation of the on-going (e.g., activated) on-demand SS/PBCH block transmission.
For one further implementation, this is applicable at least when the UE does not receive any MAC CE for indicating the adaptation of the parameter for the on-going (e.g., activated) on-demand SS/PBCH block transmission.
For another further implementation, the UE determines that the on-going on-demand SS/PBCH block transmission terminates after the number of bursts for the on-demand SS/PBCH block transmission.

For another example, if a UE receives the higher layer parameters to indicate the activation of the on-demand SS/PBCH block transmission, and/or determines the number of bursts for the on-demand SS/PBCH block transmission (e.g., according to example in the present disclosure), then the UE does not expect to receive the MAC CE for indicating the deactivation of the on-going (e.g., activated) on-demand SS/PBCH block transmission during the number of bursts for the on-demand SS/PBCH block transmission (e.g., before the number of bursts for the on-demand SS/PBCH block transmission completes).
For one further implementation, this is applicable at least when the UE does not receive any MAC CE for indicating the adaptation of the parameter for the on-going (e.g., activated) on-demand SS/PBCH block transmission.
For another further implementation, the UE determines that the on-going on-demand SS/PBCH block transmission terminates after the number of bursts for the on-demand SS/PBCH block transmission.

For yet another example, if a UE receives the higher layer parameters to indicate the activation of the on-demand SS/PBCH block transmission, and/or determines the number of bursts for the on-demand SS/PBCH block transmission (e.g., according to example in the present disclosure), the UE may receive the MAC CE for indicating the deactivation for the on-going (e.g., activated) on-demand SS/PBCH block transmission.
For one further implementation, this is applicable at least when the UE does not receive any MAC CE for indicating the adaptation of the parameter for the on-going (e.g., activated) on-demand SS/PBCH block transmission.
For another further implementation, the UE receives the MAC CE before the number of bursts for the on-demand SS/PBCH block transmission completes.
For yet another further implementation, the UE can determine a timing after which the on-going on-demand SS/PBCH block transmission terminates, based on the received MAC CE, and terminates the on-going on-demand SS/PBCH block transmission based on the timing and the number of bursts for the on-demand SS/PBCH block transmission, which occurs earlier.

For yet another example, if a UE receives the higher layer parameters to indicate the activation of the on-demand SS/PBCH block transmission, and/or does not determine the number of bursts for the on-demand SS/PBCH block transmission (e.g., according to example in the present disclosure), then the UE may receive the MAC CE for indicating the deactivation for the on-going (e.g., activated) on-demand SS/PBCH block transmission.
For one further implementation, this is applicable at least when the UE does not receive any MAC CE for indicating the adaptation of the parameter for the on-going (e.g., activated) on-demand SS/PBCH block transmission.

For one example, if a UE receives a first MAC CE to indicate the activation of the on-demand SS/PBCH block transmission, and/or determines the number of bursts for the on-demand SS/PBCH block transmission (e.g., according to example in the present disclosure), then the UE does not expect to receive a second MAC CE for indicating the deactivation of the on-going (e.g., activated) on-demand SS/PBCH block transmission.
For one further implementation, this is applicable at least when the UE does not receive any third MAC CE for indicating the adaptation of the parameter for the on-going (e.g., activated) on-demand SS/PBCH block transmission.
For another further implementation, the UE determines that the on-going on-demand SS/PBCH block transmission terminates after the number of bursts for the on-demand SS/PBCH block transmission.

For another example, if a UE receives a first MAC CE to indicate the activation of the on-demand SS/PBCH block transmission, and/or determines the number of bursts for the on-demand SS/PBCH block transmission (e.g., according to example in the present disclosure), then the UE does not expect to receive a second MAC CE for indicating the deactivation of the on-going (e.g., activated) on-demand SS/PBCH block transmission during the number of bursts for the on-demand SS/PBCH block transmission (e.g., before the number of bursts for the on-demand SS/PBCH block transmission completes).
For one further implementation, this is applicable at least when the UE does not receive any third MAC CE for indicating the adaptation of the parameter for the on-going (e.g., activated) on-demand SS/PBCH block transmission.
For another further implementation, the UE determines that the on-going on-demand SS/PBCH block transmission terminates after the number of bursts for the on-demand SS/PBCH block transmission.

For yet another example, if a UE receives a first MAC CE to indicate the activation of the on-demand SS/PBCH block transmission, and/or determines the number of bursts for the on-demand SS/PBCH block transmission (e.g., according to example in the present disclosure), the UE may receive a second MAC CE for indicating the deactivation for the on-going (e.g., activated) on-demand SS/PBCH block transmission.
For one further implementation, this is applicable at least when the UE does not receive any third MAC CE for indicating the adaptation of the parameter for the on-going (e.g., activated) on-demand SS/PBCH block transmission.
For another further implementation, the UE receives the second MAC CE before the number of bursts for the on-demand SS/PBCH block transmission completes.
For yet another further implementation, the UE can determine a timing after which the on-going on-demand SS/PBCH block transmission terminates, based on the received second MAC CE, and terminates the on-going on-demand SS/PBCH block transmission based on the timing and the number of bursts for the on-demand SS/PBCH block transmission, which occurs earlier.

For yet another example, if a UE receives a first MAC CE to indicate the activation of the on-demand SS/PBCH block transmission, and/or does not determine the number of bursts for the on-demand SS/PBCH block transmission (e.g., according to example in the present disclosure), then the UE may receive a second MAC CE for indicating the deactivation for the on-going (e.g., activated) on-demand SS/PBCH block transmission.
For one further implementation, this is applicable at least when the UE does not receive any third MAC CE for indicating the adaptation of the parameter for the on-going (e.g., activated) on-demand SS/PBCH block transmission.

For one example, if a UE receives a first MAC CE to indicate the adaptation of parameter for the on-demand SS/PBCH block transmission, and determines the number of bursts for the on-demand SS/PBCH block transmission (e.g., according to example in the present disclosure), then the UE does not expect to receive a second MAC CE for indicating the deactivation of the on-going (e.g., activated) on-demand SS/PBCH block transmission.
For one further implementation, the UE determines that the on-going on-demand SS/PBCH block transmission terminates after the number of bursts for the on-demand SS/PBCH block transmission.

For another example, if a UE receives a first MAC CE to indicate the adaptation of parameter for the on-demand SS/PBCH block transmission, and/or determines the number of bursts for the on-demand SS/PBCH block transmission (e.g., according to example in the present disclosure), then the UE does not expect to receive a second MAC CE for indicating the deactivation of the on-going (e.g., activated) on-demand SS/PBCH block transmission during the number of bursts for the on-demand SS/PBCH block transmission (e.g., before the number of bursts for the on-demand SS/PBCH block transmission completes).
For one further implementation, the UE determines that the on-going on-demand SS/PBCH block transmission terminates after the number of bursts for the on-demand SS/PBCH block transmission.

For yet another example, if a UE receives the a first MAC CE to indicate the adaptation of parameter for the on-demand SS/PBCH block transmission, and/or determines the number of bursts for the on-demand SS/PBCH block transmission (e.g., according to example in the present disclosure), the UE may receive a second MAC CE for indicating the deactivation for the on-going (e.g., activated) on-demand SS/PBCH block transmission.
For one further implementation, the UE receives the second MAC CE before the number of bursts for the on-demand SS/PBCH block transmission completes.
For another further implementation, the UE can determine a timing after which the on-going on-demand SS/PBCH block transmission terminates, based on the received second MAC CE, and terminates the on-going on-demand SS/PBCH block transmission based on the timing and the number of bursts for the on-demand SS/PBCH block transmission, which occurs earlier.

For yet another example, if a UE receives a first MAC CE to indicate the adaptation of parameter for the on-demand SS/PBCH block transmission, and/or does not determine the number of bursts for the on-demand SS/PBCH block transmission (e.g., according to example in the present disclosure), then the UE may receive a second MAC CE for indicating the deactivation for the on-going (e.g., activated) on-demand SS/PBCH block transmission.

In the present disclosure, an example timeline for adaptation of an on-demand SSB transmission by MAC CE is provided.

In one embodiment, when the PDSCH reception providing the MAC CE for indicating the adaptation of parameter for the on-demand SS/PBCH block transmission ends in slot n, the UE expects that the on-demand SS/PBCH block transmission according to the indicated parameter by the MAC CE starts from:
a first slot after (or no earlier than) slot n+T, that includes the candidate SS/PBCH block occasion corresponding to the first transmitted SS/PBCH block index after adaptation and is located in a first half frame within the half frames for the on-demand SS/PBCH block transmission, if the slot n+T is not within a first slot to a last slot with on-going (e.g., activated and using the parameter(s) before adaptation) transmission of the on-demand SS/PBCH blocks in a half frame (e.g., the slot n+T is not within an on-going on-demand SS/PBCH block transmission burst according to parameter(s) before adaptation); or
a first slot after (or no earlier than) the last slot (e.g., the slot including the candidate SS/PBCH block occasion corresponding to the last transmitted SS/PBCH block index before adaptation for the on-going on-demand SS/PBCH block transmission burst overlapping with slot n+T), that includes the candidate SS/PBCH block occasion to the first transmitted SS/PBCH block index after adaptation and is located in a first half frame within the half frames for the on-demand SS/PBCH block transmission, if the slot n+T is within a first slot to a last slot with on-going (e.g., activated and using the parameter before adaptation) transmission of the on-demand SS/PBCH blocks in a half frame (e.g., the slot n+T is within an on-going on-demand SS/PBCH block transmission burst according to parameter(s) before adaptation);
   wherein T is the processing delay of the MAC CE, e.g., T=m+3*N_slot\hat{ }{subframe,μ}+1, slot n+m is the one for PUCCH transmission with HARQ-ACK information for the PDSCH, and N_slot\hat{ }{subframe, μ} is a number of slots per subframe for the SCS configuration μcorresponding to the PUCCH transmission.

In another embodiment, when the PDSCH reception providing the MAC CE for indicating the adaptation of parameter for the on-demand SS/PBCH block transmission ends in slot n, the UE expects that the on-demand SS/PBCH block transmission according to the indicated parameter by the MAC CE starts from a first slot after (or no earlier than) slot n+T, that includes the candidate SS/PBCH block occasion corresponding to the first transmitted SS/PBCH block index after adaptation, and is located in a first half frame within the half frames for the on-demand SS/PBCH block transmission, wherein T is the processing delay of the MAC CE, e.g., T=m+3*N_slot\hat{ }{subframe,μ}+1, slot n+m is the one for PUCCH transmission with HARQ-ACK information for the PDSCH, and N_slot\hat{ }{subframe, μ} is a number of slots per subframe for the SCS configuration μ corresponding to the PUCCH transmission.

In one embodiment, when a SS/PBCH block transmission is adapted by at least one of the parameter in the configuration, the UE can assume that a set of valid ROs determined based on the SS/PBCH block transmission maintain the same before and after the adaptation, or the UE can assume that the set of valid ROs determined based on the SS/PBCH block transmission is not impacted by the adaptation.
For one example, the SS/PBCH block can be on-demand SS/PBCH block;
For another example, the SS/PBCH block can be periodic SS/PBCH block;
For yet another example, the adaptation can be triggered by a MAC CE;
For yet another example, the adaptation can be triggered by a DCI format;
For yet another example, the adaptation can be triggered by a wake-up-signal (WUS);
For yet another example, the adapted parameter can be at least one from the following components:
   Component 1: A periodicity for the SS/PBCH block burst or transmission.
   Component 2: A SFN offset indicating the SFN for the SS/PBCH block burst or transmission.
   Component 3: A half frame index indicating the half frame in the SFN for the SS/PBCH block burst or transmission.
   Component 4: An indication of actually transmitted SSB (indices) in a burst for the SS/PBCH block burst or transmission.
   Component 5: A number of bursts for the SS/PBCH block transmission.
For yet another example, the UE can further assume that the mapping between the set of (valid) ROs and the SS/PBCH blocks maintain the same, before and after adaptation.
For yet another example, the UE can further assume that the mapping between the set of (valid) ROs and the SS/PBCH blocks is not impacted by the adaptation.

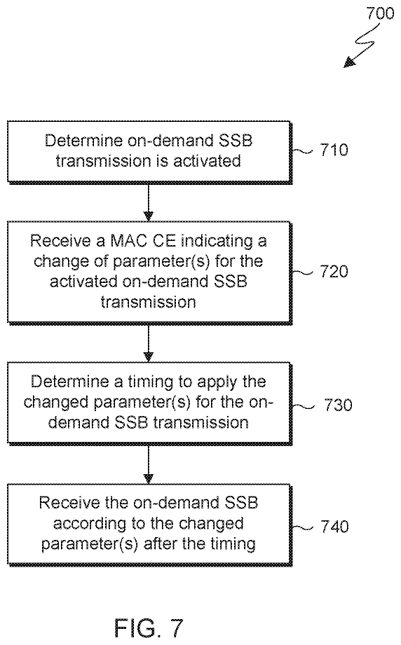

FIG. 7 illustrates an example method 700 for using a MAC CE to adapt parameters for an on-demand SS/PBCH block transmission that may be performed by a UE in a wireless communication system according to embodiments of the present disclosure. The method 700 of can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method 700 begins with a UE determining that an on-demand SSB transmission is activated (710). The UE then receives a MAC CE indicating a change of parameter(s) for the activated on-demand SSB transmission (720). The UE then determines a timing to apply the changed parameter(s) for the on-demand SSB transmission (730). The UE then receives the on-demand SSB according to the changed parameter(s) after the determined timing (740).

Although FIG. 7 illustrates one example method 700 of the actions taken by the UE for adapting parameters for an on-demand SS/PBCH block transmission, various changes may be made to FIG. 7. For example, while shown as a series of steps, various steps in FIG. 7 could overlap, occur in parallel, occur in a different order, or occur any number of times.

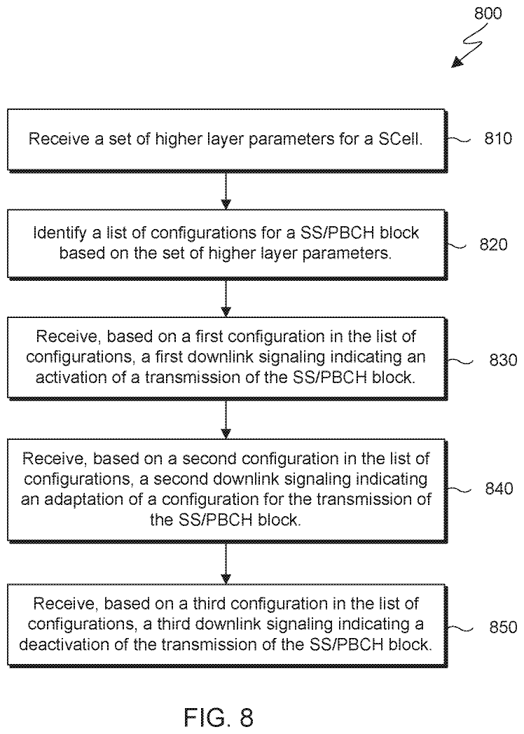

FIG. 8 illustrates an example method 800 performed by a UE in a wireless communication system according to embodiments of the present disclosure. The method 800 of can be performed by any of the UEs 111-116 of FIG. 1, such as the UE 116 of FIG. 3, and a corresponding method can be performed by any of the BSs 101-103 of FIG. 1, such as BS 102 of FIG. 2. The method 800 is for illustration only and other embodiments can be used without departing from the scope of the present disclosure.

The method 800 begins with the UE receiving a set of higher layer parameters for a SCell (810). The UE then identifies a list of configurations for a SS/PBCH block based on the set of higher layer parameters (820). For example, in 820, each configuration in the list of configurations includes a periodicity for the SS/PBCH block, a SFN offset for the SS/PBCH block, a half frame index for the SS/PBCH block, and an indication of actually transmitted SS/PBCH block indexes for the SS/PBCH block. In various embodiments, the SS/PBCH block is an on-demand SS/PBCH block.

The UE then receives, based on a first configuration in the list of configurations, a first downlink signaling indicating an activation of a transmission of the SS/PBCH block (830). In various embodiments, the set of higher layer parameters includes an indication of the first configuration applied to the transmission of the SS/PBCH block. The UE then receives, based on a second configuration in the list of configurations, a second downlink signaling indicating an adaptation of a configuration for the transmission of the SS/PBCH block (840). In various embodiments, the second downlink signaling is received when the SCell is activated.

The UE then receives, based on a third configuration in the list of configurations, a third downlink signaling indicating a deactivation of the transmission of the SS/PBCH block (850). In various embodiments, the first downlink signaling is from the set of higher layer parameters or a MAC CE. The second downlink signaling is a second MAC CE. The third downlink signaling is a third MAC CE. In various embodiments, a maximum number of configurations in the list of configurations is 16. The first MAC CE, the second MAC CE, and the third MAC CE each include 4 bits to indicate an index of the first configuration, the second configuration, and the third configuration, respectively. In various embodiments, the UE determines a first number of bursts for the SS/PBCH block, based on the first configuration, when the first downlink signaling is first MAC CE and determines a second number of bursts for the SS/PBCH block, based on the second configuration.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of higher layer parameters for a secondary cell (SCell); and
a processor operably coupled to the transceiver, the processor configured to identify, based on the set of higher layer parameters, a list of configurations for a synchronization signal and physical broadcast channel (SS/PBCH) block, wherein each configuration in the list of configurations includes:
a periodicity for the SS/PBCH block;
a system frame number (SFN) offset for the SS/PBCH block;
a half frame index for the SS/PBCH block; and
an indication of actually transmitted SS/PBCH block indexes for the SS/PBCH block,
wherein the transceiver is further configured to:
receive, based on a first configuration in the list of configurations, a first downlink signaling indicating an activation of a transmission of the SS/PBCH block;
receive, based on a second configuration in the list of configurations, a second downlink signaling indicating an adaptation of a configuration for the transmission of the SS/PBCH block; and
receive, based on a third configuration in the list of configurations, a third downlink signaling indicating a deactivation of the transmission of the SS/PBCH block.

2. The UE of claim 1, wherein:
the first downlink signaling is from the set of higher layer parameters or a first medium access control (MAC) control element (CE);
the second downlink signaling is a second MAC CE; and
the third downlink signaling is a third MAC CE.

3. The UE of claim 2, wherein:
a maximum number of configurations in the list of configurations is 16, and
the first MAC CE, the second MAC CE, and the third MAC CE each include 4 bits to indicate an index of the first configuration, the second configuration, and the third configuration, respectively.

4. The UE of claim 2, wherein the set of higher layer parameters includes an indication of the first configuration applied to the transmission of the SS/PBCH block.

5. The UE of claim 2, wherein the processor is further configured to:
determine a first number of bursts for the SS/PBCH block, based on the first configuration, when the first downlink signaling is first MAC CE; and
determine a second number of bursts for the SS/PBCH block, based on the second configuration.

6. The UE of claim 1, wherein the second downlink signaling is received when the SCell is activated.

7. The UE of claim 1, wherein the SS/PBCH block is an on-demand SS/PBCH block.

8. A method of a user equipment (UE) in a wireless communication system, the method comprising:
receiving a set of higher layer parameters for a secondary cell (SCell);
identifying, based on the set of higher layer parameters, a list of configurations for a synchronization signal and physical broadcast channel (SS/PBCH) block, wherein each configuration in the list of configurations includes:
a periodicity for the SS/PBCH block;
a system frame number (SFN) offset for the SS/PBCH block;
a half frame index for the SS/PBCH block; and
an indication of actually transmitted SS/PBCH block indexes for the SS/PBCH block;
receiving, based on a first configuration in the list of configurations, a first downlink signaling indicating an activation of a transmission of the SS/PBCH block;
receiving, based on a second configuration in the list of configurations, a second downlink signaling indicating an adaptation of a configuration for the transmission of the SS/PBCH block; and
receiving, based on a third configuration in the list of configurations, a third downlink signaling indicating a deactivation of the transmission of the SS/PBCH block.

9. The method of claim 8, wherein:
the first downlink signaling is from the set of higher layer parameters or a first medium access control (MAC) control element (CE);
the second downlink signaling is a second MAC CE; and
the third downlink signaling is a third MAC CE.

10. The method of claim 9, wherein:
a maximum number of configurations in the list of configurations is 16, and
the first MAC CE, the second MAC CE, and the third MAC CE each include 4 bits to indicate an index of the first configuration, the second configuration, and the third configuration, respectively.

11. The method of claim 9, wherein the set of higher layer parameters includes an indication of the first configuration applied to the transmission of the SS/PBCH block.

12. The method of claim 9, further comprising:
determining a first number of bursts for the SS/PBCH block, based on the first configuration, when the first downlink signaling is first MAC CE; and
determining a second number of bursts for the SS/PBCH block, based on the second configuration.

13. The method of claim 8, wherein the second downlink signaling is received when the SCell is activated.

14. The method of claim 8, wherein the SS/PBCH block is an on-demand SS/PBCH block.

15. A base station (BS) in a wireless communication system, the BS comprising:
a processor configured to determine a list of configurations for a synchronization signal and physical broadcast channel (SS/PBCH) block, wherein each configuration in the list of configurations includes:
a periodicity for the SS/PBCH block;
a system frame number (SFN) offset for the SS/PBCH block;
a half frame index for the SS/PBCH block; and
an indication of actually transmitted SS/PBCH block indexes for the SS/PBCH block; and
a transceiver operably coupled to the processor, the transceiver configured to:
transmit a set of higher layer parameters for a secondary cell (SCell), wherein the set of higher layer parameters includes the list of configurations;
transmit, based on a first configuration in the list of configurations, a first downlink signaling indicating an activation of a transmission of the SS/PBCH block;
transmit, based on a second configuration in the list of configurations, a second downlink signaling indicating an adaptation of a configuration for the transmission of the SS/PBCH block; and
transmit, based on a third configuration in the list of configurations, a third downlink signaling indicating a deactivation of the transmission of the SS/PBCH block.

16. The BS of claim 15, wherein:
the first downlink signaling is from the set of higher layer parameters or a first medium access control (MAC) control element (CE);
the second downlink signaling is a second MAC CE; and
the third downlink signaling is a third MAC CE.

17. The BS of claim 16, wherein:
a maximum number of configurations in the list of configurations is 16, and
the first MAC CE, the second MAC CE, and the third MAC CE each include 4 bits to indicate an index of the first configuration, the second configuration, and the third configuration, respectively.

18. The BS of claim 16, wherein the set of higher layer parameters includes an indication of the first configuration applied to the transmission of the SS/PBCH block.

19. The BS of claim 16, wherein the processor is further configured to:
determining a first number of bursts for the SS/PBCH block, based on the first configuration, when the first downlink signaling is first MAC CE; and
determining a second number of bursts for the SS/PBCH block, based on the second configuration.

20. The BS of claim 15, wherein the second downlink signaling is received when the SCell is activated, and the SS/PBCH block is an on-demand SS/PBCH block.
